(19) United States
(12) Patent Application Publication
(10) Pub. No.: US 2025/0178903 A1
(43) Pub. Date: Jun. 5, 2025

(54) METHOD FOR RECOVERING MATERIALS FROM WASTE OR SCRAPS THROUGH AN IMPROVED CARBOTHERMAL PROCESS

(71) Applicants: UNIVERSITA' DEGLI STUDI DI BRESCIA, Brescia (IT); CONSORZIO INTERUNIVERSITARIO NAZIONALE PER LA SCIENZA E TECNOLOGIA DEI MATERIALI (INSTM), Firenze (IT)

(72) Inventors: Elza BONTEMPI, Brescia (IT); Laura Eleonora DEPERO, Brescia (IT); Ario FAHIMI, Brescia (IT); Patrizia FRONTERA, Pellaro (Reggio Calabria) (IT)

(21) Appl. No.: 18/833,600

(22) PCT Filed: Feb. 6, 2023
(86) PCT No.: PCT/IB2023/051034

§ 371 Date: Jul. 26, 2024

(30) Foreign Application Priority Data
Feb. 9, 2022 (IT) 102022000002351

(51) Int. Cl. C01B 25/30; C01D 15/02; C01G 45/022; C01G 53/04; C01G 53/06; C22B 5/10; C22B 7/00; C22B 26/12; H01M 10/54

(52) U.S. Cl. CPC C01B 25/30; C01D 15/02; C01G 45/022; C01G 53/04; C01G 53/06; C22B 5/10; C22B 7/001; C22B 26/12; H01M 10/54; C01P 2002/72

(57) ABSTRACT

A method for recovering materials from waste or scraps through an improved microwave carbothermal process involves combining reagents of a carbothermal reaction to form a mixture to be subjected to heat treatment, the reagents including a component in which an element to be recovered is contained and a carbon-containing component, the component being contained within a waste material, placing the mixture in a crucible, placing the crucible in a refractory chamber having a side wall, a surface of the side wall being covered by a layer of microwave-sensitive material, and inserting the refractory chamber into a microwave oven. The carbothermal reaction is obtained in less time and with lower electricity consumption compared to typical carbothermal reactions.

The present invention relates to a method for recovering materials from waste or scraps through an improved carbothermal process.

Carbothermal reactions involve the reduction (change of oxidation state) of elements, often metals, using a carbon-containing substance (e.g. coal, coke, charcoal, vegetable charcoal, etc.) as a reducing agent. These processes are also applied to obtain elementary forms of many elements.

Carbothermal reactions are generally conducted at very high temperatures, of several hundred degrees Celsius, and require the consumption of high energy. At an industrial level, non-renewable energy sources are generally used to carry out these reactions.

The object of the present invention is to provide a method for recovering even critical materials (some oxides for example) and/or elements (such as Al, Fe, Cu, Co, Ni, Zn, Pb) such as phosphorus in the ashes (for example of biomass), from production waste or scraps of any type. Furthermore, the object of the present invention is that of recovering elements effectively, without the need to resort to the use of high energies.

This object is achieved by a method for recovering elements from waste material through an improved microwave carbothermal process with the use of an insert which amplifies the heating efficiency. This object is achieved by a method according to claim 1 and by a refractory chamber according to claim 9. The dependent claims disclose further advantageous embodiments of the invention.

The features and advantages of the method according to this invention will become apparent from the following description, given as a non-limiting example in accordance with the figures in the accompanying drawings, in which:

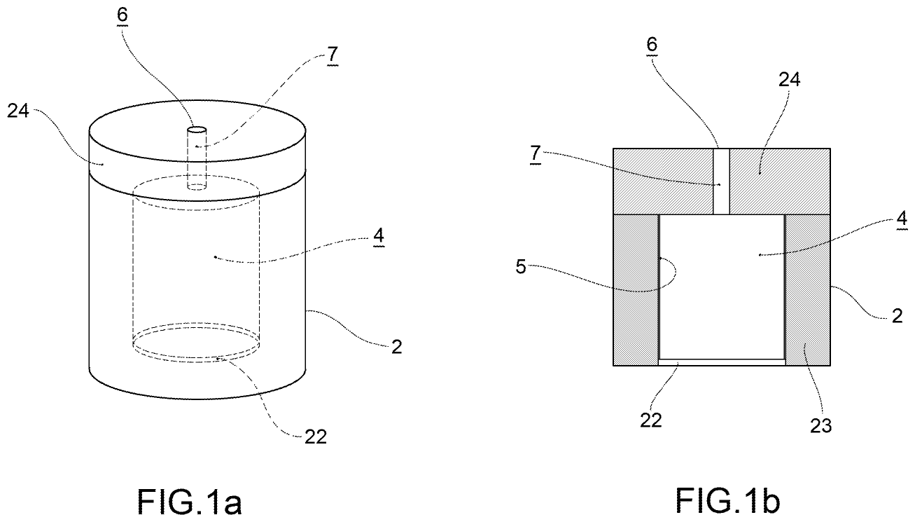

FIGS. 1A and 1B show an axonometric view and a sectional view, respectively, of a refractory chamber according to the present invention;

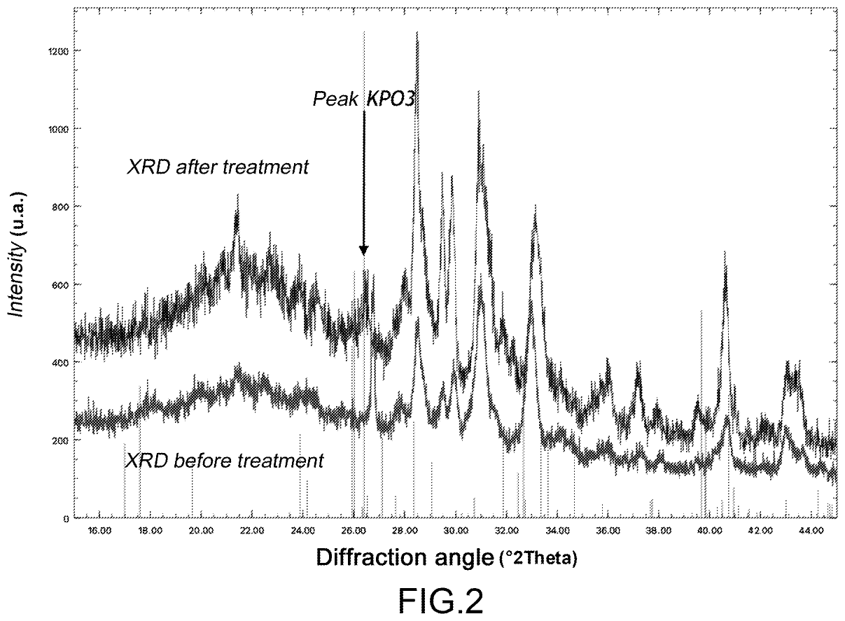

FIG. 2 refers to embodiment example A, and shows the XRD spectrum (X-ray diffractometry or X-ray diffraction) of sample PP8, which shows the KPO3 peak after treatment in a microwave oven with insert;

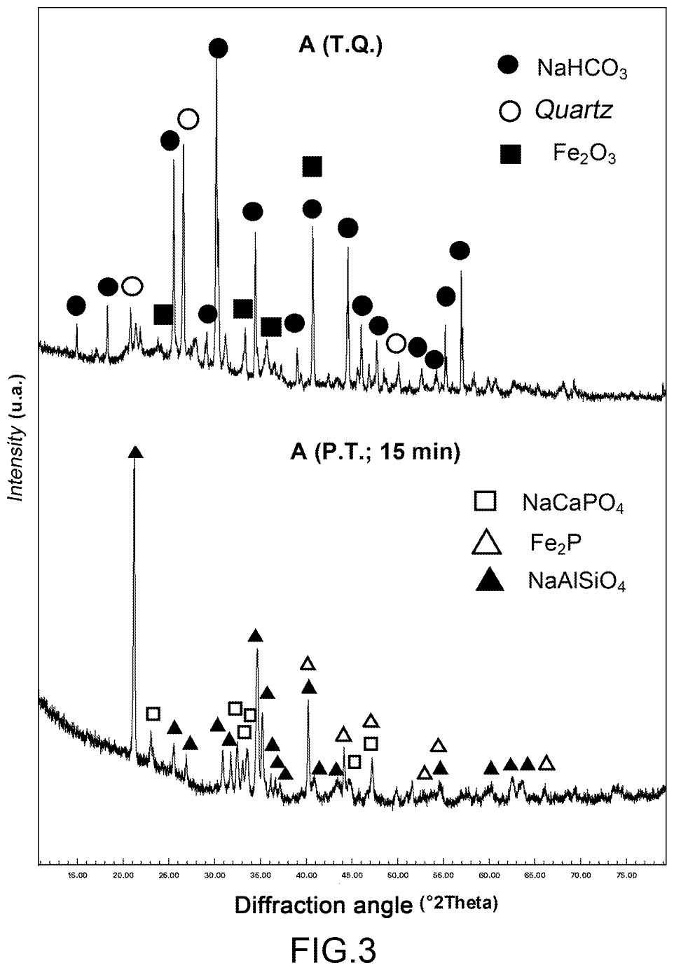

FIG. 3 refers to embodiment example B, and shows the diffraction spectrum of sample A as such (T.Q.; top) and post-treatment (P.T.; bottom);

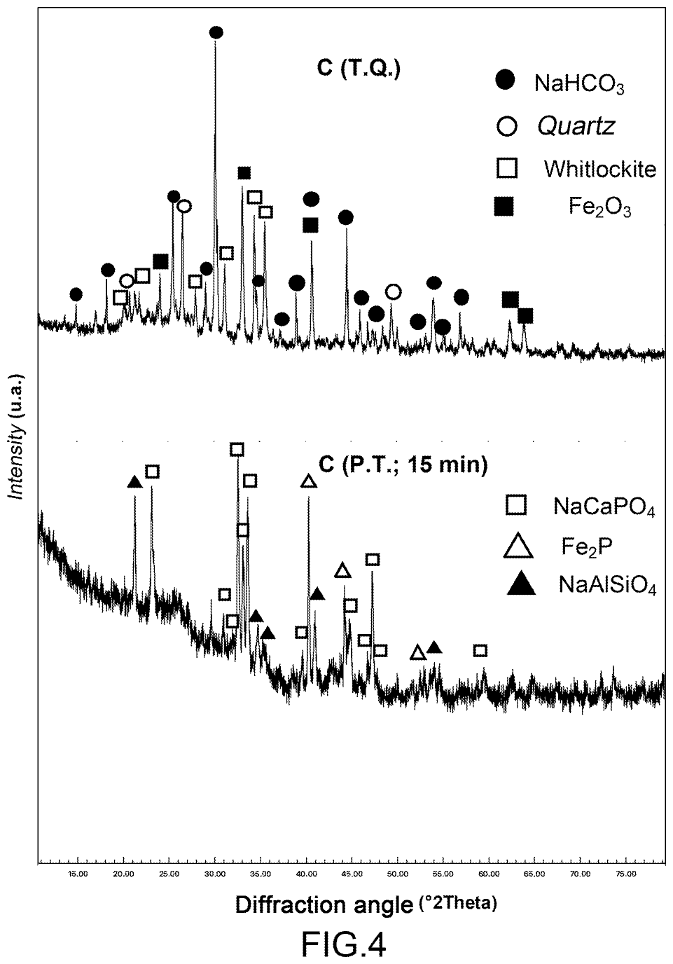

FIG. 4 refers to embodiment example B, and shows the diffraction spectrum of sample C as such (T.Q.; top) and post-treatment (P.T.; bottom);

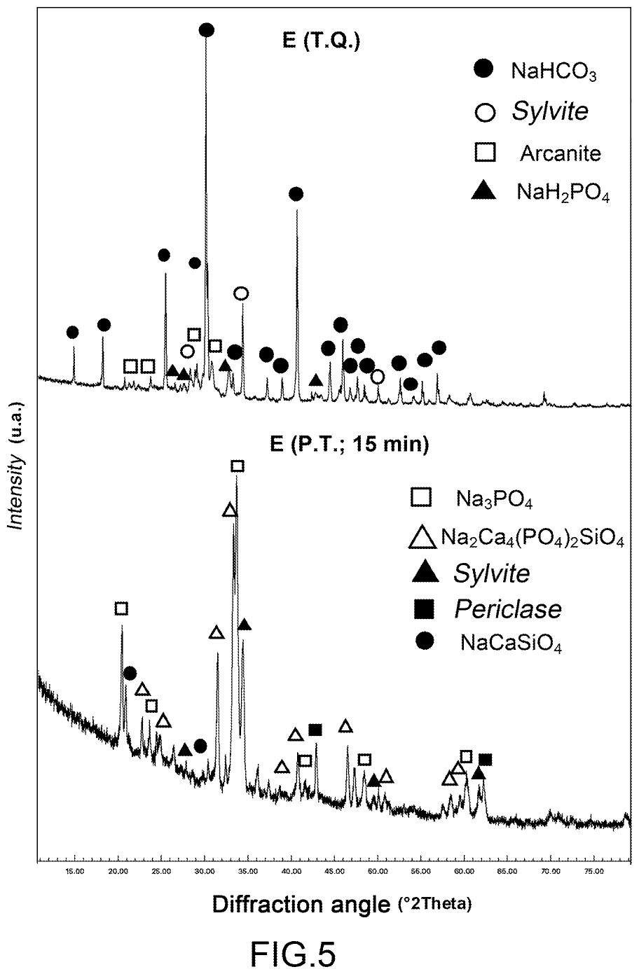

FIG. 5 refers to embodiment example B, and shows the diffraction spectrum of sample E as such (T.Q.; top) and post-treatment (P.T.; bottom);

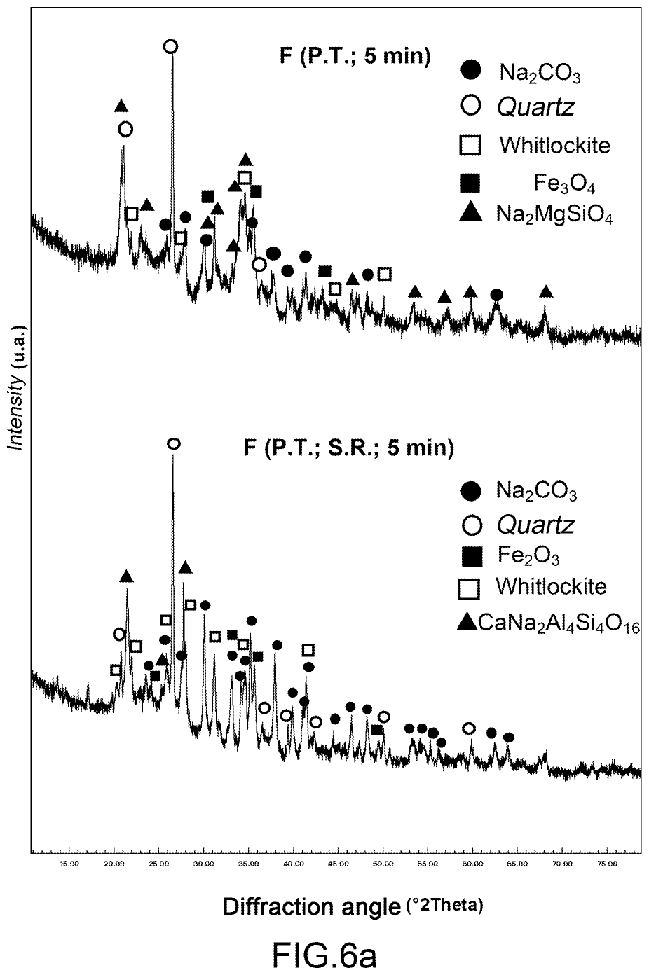

FIG. 6A refers to embodiment example C, and shows the diffraction spectrum of sample F 5 minutes post-treatment with a refractory chamber (P.T.; top) and post-treatment without a refractory chamber (P.T.; S.R.; bottom); FIG. 6B after 10 minutes, and FIG. 6C after 15 minutes;

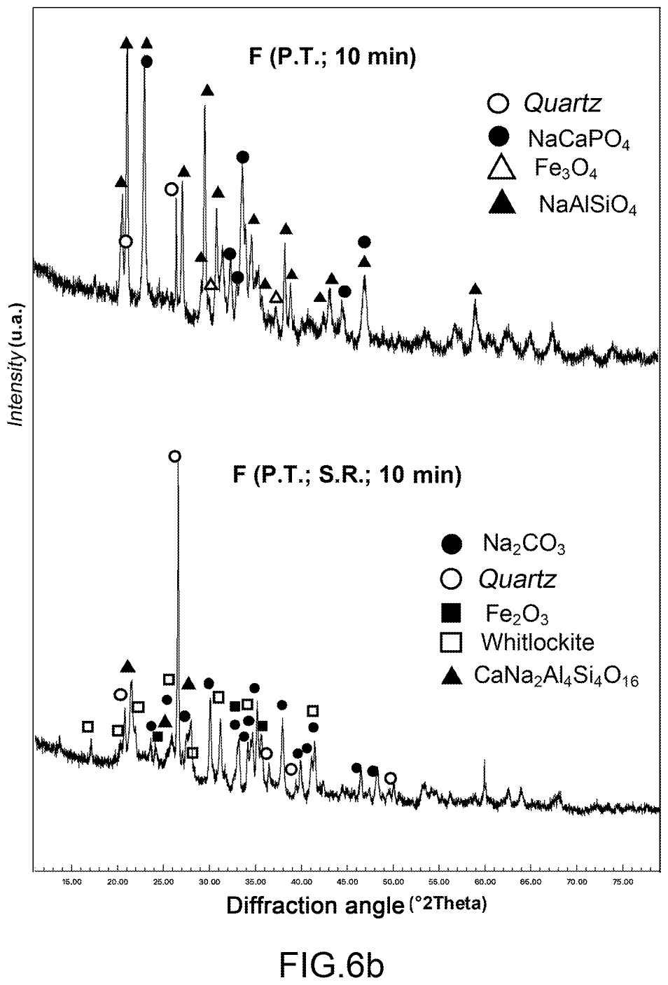

FIG. 7 shows the crucible containing the substance to be subjected to the carbothermal treatment, inserted in the refractory chamber of FIG. 1b, the refractory chamber in turn being inserted in a microwave oven;

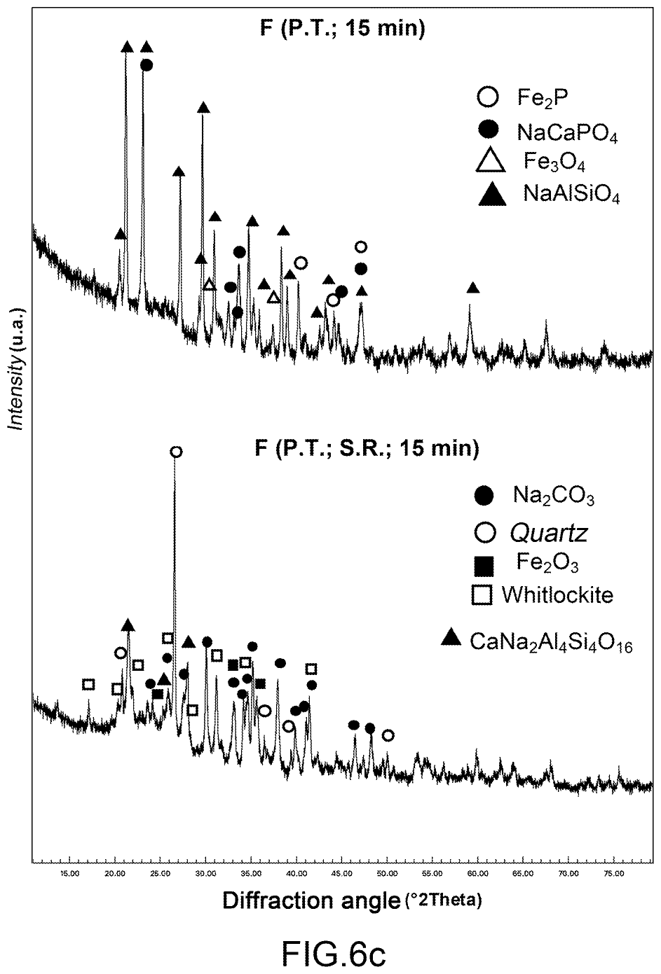

FIG. 8 shows, in the refractory chamber of FIG. 1b, a bell for a controlled atmosphere, in which the crucible is placed.

Carbothermal reactions involve the reduction of compounds (often oxides) using carbon as the reducing agent. The method according to the present invention provides for the induction of heating in the carbothermal reactions by means of microwaves, using for example carbon as the reducing agent (generally in the form of graphite or anthracite). Furthermore, the method according to the present invention provides for the use of at least one special insert, in particular a refractory chamber, which allows the heating of the materials obtained to be optimized by virtue of the use of microwaves.

The object of the present invention is therefore a method for recovering an element M (or an oxide thereof obtained from the carbothermal reaction) from waste material through an improved microwave carbothermal process with the use of at least one insert which amplifies the heating efficiency.

A typical carbothermal reaction may be written (in a simplified manner) as follows:

MO+C→M+CO
MO: starting material (for example contained in a scrap, or a matrix of a different type) in which M is the element to be recovered
M: element to be recovered, referred to as element to be reduced M
C: carbon
O: oxygen

For example, in the case of iron recovery (M=Fe), the reaction becomes:

Fe₂O₃+3CO→2Fe+3CO₂

For example, in the case of silicon recovery (M=Si), the reaction becomes:

3SiO₂+9C→3SiC+6CO

The process also provides for the recovery of an element contained in a phase (for example an oxide) from an oxidation state to a lower oxidation state. For example:

4LiNiO₂(s)+C(s)→2Li₂O(s)+4NiO(s)+CO₂(g)

In this case, lithium oxide and nickel oxide are recovered.

The starting waste material (which contains MO and therefore in which the element to be reduced M is contained) may be a powder, an ash (deriving for example from incineration, waste-to-energy processes, pyrolysis processes, etc.), a slag (obtained as an industrial by-product), a sludge, or any material containing an oxidized element which may be transformed into a reduced form thereof.

The starting waste material may also already be pre-treated, chemically or thermally. In the case of sludge, for example, it may be dehydrated sludge or sludge stabilized with additives.

The starting waste material MO may be a phase contained in a matrix, such as a metal oxide contained in a sand.

If necessary, other substances, or Y additives, may be added to promote certain reactions.

As an example, the following phosphorus recovery reaction (M=P) is given, in which silicon oxide was added as an additive to promote the reaction (Y=SiO2):

2Ca₃(PO₄)₂+10C+3SiO₂->3Ca₂SiO₄+10CO+2P₂

For example, in the above phosphorus recovery reaction, the starting waste material [Ca3(PO4)2] is derived from biomass ashes, and the additive to promote the reaction (3SiO2) is a by-product of the industry which deals with iron and silicon alloys (silica fume).

Below is a further example of phosphorus recovery, shown in the top portion of FIGS. 6B and 6C, in which the calcium phosphate (Ca₃(PO₄)₂), for example also in amorphous form or in the form of Whitlockite, is transformed into a sodium phosphate (Na₃PO₄) or sodium and calcium phosphate (CaNaPO₄) by means of the microwave carbothermal process according to the present invention. According to this example, the following is mixed: 60% by mass of sludge ashes, 25% sodium bicarbonate (NaHCO₃) and 15% graphite. The treatment was in a microwave oven, setting the MW power to 1000 W for 15 minutes. As may be seen in FIGS. 6B and 6C, the bioavailable CaNaPO₄ (buchwaldite) phase was formed from the carbothermal process. It should be noted that any other carbon-rich reducing material, such as dehydrated sludge, may be used instead of graphite. Instead of sodium bicarbonate, another salt may be used, for example a chloride or a carbonate, of sodium or potassium, or a bromide or an iodide. It is also possible to add silica fume. The reaction may be summarized as follows:

Ca₃(PO₄)₂+6NaHCO₃→2Na₃PO₄+3Ca(OH)₂+6CO₂

Advantageously, the method according to the present invention requires that at least some of the reagents, preferably all of them, derive from and/or are contained in waste or by-products.

The method that is the object of the present is a method for recovering materials from waste or scraps through an improved microwave carbothermal process with the use of a refractory chamber. This method includes the steps of:
combining the reagents of the carbothermal reaction forming the mixture 80 to be subjected to heat treatment, i.e. the component MO in which the element M to be recovered is contained, the component C containing carbon and any additive Y; wherein the component MO, and preferably also the component C and/or Y, are waste materials;
placing the mixture 80 in a crucible 90 preferably provided with a cover, said crucible preferably being made of a microwave-sensitive material, i.e. which is capable of absorbing electromagnetic energy and transforming it into heat, such as for example carbon, graphite, or silicon carbide;
placing the crucible 90 in a refractory chamber 2 comprising a side wall 23 surrounding an inner chamber 4 in which the crucible is arranged; wherein said side wall 23 is made of a refractory material and is provided with a surface facing the inner chamber 4; and wherein said surface of the side wall 23 is covered by a layer 5 made of microwave-sensitive material;
inserting the refractory chamber into a microwave oven 80 operated at a certain power W for a certain time T.

Preferably, the crucible in which the mixture to be subjected to heat treatment is inserted is cylindrical and provided with a cover. Preferably, the crucible is made of graphite.

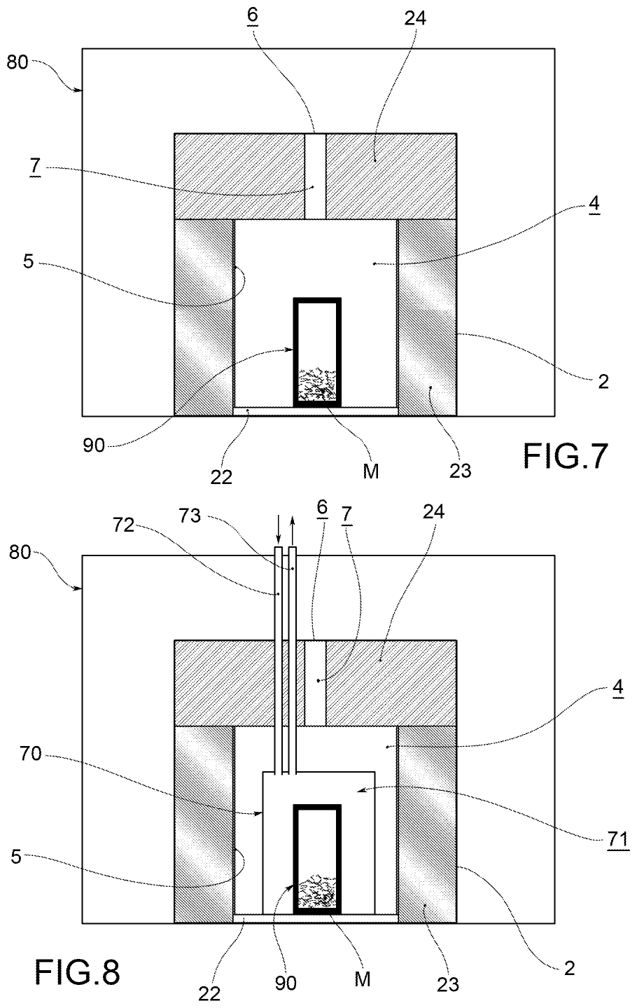

Preferably, the refractory chamber 2 in which the crucible containing the mixture to be subjected to heat treatment is inserted is shown in FIG. 9.

The refractory chamber 2, which is preferably cylindrical but which may also assume different geometries and dimensions, comprises a side wall 23 which surrounds an inner chamber 4 in which the crucible is placed.

Preferably, the refractory chamber 2 comprises an upper wall 24, integral with or separate from the side wall 23, which closes the inner chamber 4 at the top. The upper wall 24, if present, comprises a vent channel 7, which connects the inner chamber 4 with the external environment. The vent channel 7 terminates in an upper opening 6.

Preferably, the refractory chamber 2 comprises a bottom wall 22, integral with or separate from the side wall 23, which closes the inner chamber 4 at the bottom. The crucible is supported on the bottom wall 23, if present.

The refractory chamber 2, and in particular at least the side wall 23, is made of refractory material, for example ceramic, so as to retain the heat inside the inner chamber 4. Preferably, also the upper wall of the refractory chamber 24 and/or the bottom wall 22 is made of refractory material, for example ceramic.

The surface of the side wall 23 facing the inner chamber 4 is covered by a layer 5 of microwave-sensitive material, i.e. which is capable of absorbing electromagnetic energy and transforming it into heat. The layer 5 is for example made of graphite, carbon or silicon carbide.

The refractory chamber 2 is made of refractory material, for example ceramic, and at least the side surface of the inner chamber is covered with a layer 5 of graphite. The use of a circular wall made of refractory material covered with graphite allows the microwave radiation to be reflected towards the center of the inner chamber 4. Thus, with the refractory chamber 2 located essentially centrally within the microwave oven, the concentration of microwave radiation is much higher within the inner chamber 4 than in the area outside the refractory chamber 2.

Advantageously, the refractory chamber 2 according to the present invention is internally covered with a layer 5 of sensitive material capable of increasing the effect of the microwaves. Comparative tests were carried out with a refractory chamber without an internal lining of sensitive material and the results are summarized in the table below.

| | | | Refractory chamber | Refractory chamber |
|---|---|---|---|---|
| | | | without internal lining | with internal lining |
| | Power | Time | of sensitive material | of sensitive material |
| Sample | (W) | (mins) | Weight loss % | Weight loss % |
| P1 | 1000 | 4 | 10 | 29 |
| P3 | 440 | 12 | 5 | 30 |

As may be seen from the higher percentage of weight loss measured, the process carried out in the refractory chamber according to the present invention is much more efficient, even three times as much compared to the tests carried out in a refractory chamber without an internal lining of sensitive material.

Furthermore, the process carried out in a refractory chamber according to the present invention requires a much shorter heating time than conventional heating methods.

In an embodiment example, a bell 70 is positioned inside the refractory chamber 2, which bell defines inside it a controlled atmosphere compartment 71 into which the crucible 90 containing the mixture to be subjected to carbothermal treatment is inserted. The bell 70 is made of material transparent to microwaves, and is provided with an inlet channel 72 and an outlet channel 73 for a gas. For example, the bell 70 is made of ceramic or glass.

The method that is the object of the present invention finds application in, for example, but is not limited to: the recovery of phosphorus (P) in biomass ashes (examples A and B); the recovery of critical elements such as metals in batteries (Li, Co, Mn, Cu, Zn, etc., example C); the recovery of other elements (Al, Fe, Cu, Co, Ni, Zn, Pb, etc.) from production waste or scrap of any type; the production of graphene from waste containing silica.

Furthermore, this method is applicable to the production of hydrogen from methane and an alkali metal hydroxide, preferably obtained as an industrial by-product, in which the hydroxide reacts with carbon monoxide to form a carbonate. In this case the reaction is for example:

2NaOH+CH₄→Na₂CO₃+2H₂

The method that is the object of the present invention may be followed by a recovery step (which is for example selective) by a wet process (for example with the use of solutions at different pH values) of the material of interest.

The table below indicates the carbothermal reduction conditions in a muffle (standard treatment used as a reference of the prior art) and in a microwave oven with the addition of at least one insert according to the present invention. The conditions have been selected to obtain, through the present invention, and therefore with a microwave oven and insert, the same temperatures and therefore the same results in terms of carbothermal reduction which may be obtained in a standard system with a muffle.

TABLE 1
Microwave carbothermal reduction, with
and without a refractory chamber

| | Standard | | Energy | With | | Energy |
|---|---|---|---|---|---|---|
| T | with | Time | required | refractory | Time | required |
| (C. °) | muffle | (mins) | (MJ/Kg) | chamber | (mins) | (MJ/kg) |
| 900 | 2500 W | 60 | 19.6 | 900 W | 10 | 1.13 |
| 900 | 2500 W | 45 | 14.7 | 900 W | 5 | 0.59 |
| 600 | 1000 W | 60 | 7.85 | 540 W | 10 | 0.58 |
| 600 | 1000 W | 45 | 5.89 | 540 W | 5 | 0.35 |

### EMBODIMENT EXAMPLE A: RECOVERY OF KPO3 (TO RECOVER P=PHOSPHORUS) FROM CHICKEN MANURE ASH THROUGH MICROWAVE CARBOTHERMAL PROCESS WITH INSERT

The goal of this set of experiments is to recover KPO3 as a phosphorus-based compound to support the agricultural fertilizer industry. 12 different experiments with different compositions are designed taking as reference a stoichiometric equation for carbothermal processes:

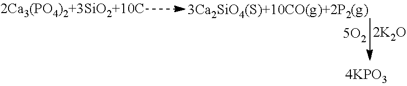

The orthophosphate-containing compound MO is combined with a material Y based on silica and carbon as an oxidizer.

Two different types of phosphorus-containing waste materials were used for the compound MO: chicken manure ash, specifically economizer fly ash, and sewage sludge ash.

For material Y, silica, two different materials were used: silica fume, a by-product of the industry that treats Fe—Si alloys, and colloidal silica as a gel.

Finally, three different materials were chosen as the carbon component: activated carbon, anthracite and graphite, each with different morphological features and a fixed carbon content in the solid matrix.

TABLE 2
Sample composition

| | Heat treatment | Component containing | Component containing | Component containing |
|---|---|---|---|---|
| Sample | conditions | P (% wt) | SiO₂ (% wt) | C (% wt) |
| PP1 | 1000 W, 4 mins | Chicken manure ash (67%) | Silica fume (23%) | Activated carbon (10%) |
| PP2 | 1000 W, 6 mins | Chicken manure ash (67%) | Silica fume (23%) | Activated carbon (10%) |
| PP3 | 1000 W, 4 mins | Chicken manure ash (75%) | Silica fume (12.5%) | Graphite (11.5%) |
| PP4 | 1000 W, 4 mins | Chicken manure ash (66%) | Silica fume (25%) | Activated carbon (9%) |
| PP5 | 1000 W, 4 mins | Chicken manure ash (77%) | Silica fume (13%) | Activated carbon (10%) |
| PP6 | 1000 W, 4 mins | Chicken manure ash (75%) | Silica fume (13%) | Activated carbon (12%) |
| PP7 | 1000 W, 4 mins | Chicken manure ash (75%) | Colloidal silica (13%) | Activated carbon (12%) |
| PP8 | 1000 W, 4 mins | Chicken manure ash (75%) | Colloidal silica (13%) | Anthracite (12%) |
| PP9 | 1000 W, 4 mins | Sewage sludge ash DE (75%) | Colloidal silica (13%) | Anthracite (12%) |
| PP10 | 1000 W, 4 mins | Sewage sludge ash CH (75%) | Colloidal silica (13%) | Anthracite (12%) |
| PP11 | 1000 W, 4 mins | Sewage sludge ash IT 1st | Colloidal silica (13%) | Anthracite (12%) |
| | | sample (75%) | | |
| PP12 | 1000 W, 4 mins | Sewage sludge ash IT 2nd | Colloidal silica (13%) | Anthracite (12%) |
| | | sample (75%) | | |

Once the sample elements are mixed, the sample is subjected to compaction by hydraulic press to form a compact disc before heat treatment.

The sample is subjected to microwave heat treatment. The samples are placed in a graphite crucible according to the present invention. Once the closing cap of the crucible has been placed thereon, the latter is inserted inside a refractory chamber 2 according to the present invention for the microwave thermochemical treatment.

The microwave oven experiments were carried out with an oven (230 V, 50 Hz) at a fixed power setting of 1000 W.

FIG. 1 shows, as an example, the XRD spectrum of the sample PP8, which exhibits the KPO3 peak after treatment in a microwave oven, demonstrating that high temperatures have been reached.

### EMBODIMENT EXAMPLE B: RECOVERY OF PHOSPHORUS (P) FROM SEWAGE SLUDGE ASHES BY MICROWAVE CARBOTHERMAL PROCESS WITH INSERT

The ash samples (element MO of the reaction) come from combustion plants located in Italy (A, B, F, G), Germany (C), Switzerland (D) and Portugal (E). All have sewage sludge as their original origin, except sample E containing poultry waste (litter).

As other components of the reaction, sodium bicarbonate (NaHCO₃) is used as the additive Y for the stabilization treatment of the ash, and anthracite (80% fixed carbon) used as the reducing agent (C) with a high calorific value for the temperature rise during the treatment step.

The proportions of the samples are shown below in Table 3.

TABLE 3
Sample composition

| | | Ash | NaHCO₃ | C (reducing) |
|---|---|---|---|---|
| Sample | Description | (% weight) | (% weight) | (% weight) |
| A | Cyclone ash from sewage sludge | 53.4 | 33.3 | 13.3 |
| | incineration (IT; 1st sample) | | | |
| B | Cyclone ash from sewage sludge | 50.5 | 36.9 | 12.6 |
| | incineration (IT; 2nd sample) | | | |
| C | Light ash from sewage sludge | 60 | 25 | 15 |
| | incineration (DE) | | | |
| D | Light ash from sewage sludge | 60 | 25 | 15 |
| | incineration (CH) | | | |
| E | Economizer ash from incineration | 51.3 | 35.9 | 12.8 |
| | of poultry litter (PT) | | | |
| F | Heavy ash from sewage sludge | 50 | 37.5 | 12.5 |
| | incineration (IT; 3rd sample) | | | |
| G | Cyclone ash from sewage sludge | 50 | 37.5 | 12.5 |
| | incineration (IT; 4th sample) | | | |

The composition is mixed and ground until the particle size is homogeneous.

The powdered samples, after being ground, are placed in a graphite crucible according to the present invention. Once the closing cap of the crucible has been placed thereon, the latter is inserted inside a refractory chamber 2 according to the present invention for the microwave thermochemical treatment of stabilization of the samples, with transformation of the phosphorus into a bio-available compound for the plants.

The microwave oven experiments were carried out with an oven (230 V, 50 Hz) at a fixed power setting of 1000 W.

Once the heat treatment has been performed, the diffraction spectra undergo significant phase variations: for samples A (FIG. 3), B and C (FIG. 4), the phosphate is present in the form of a NaCaPO4 compound which is a water-soluble phase and its ability to be absorbed by plants has been demonstrated in the literature. The innovation in this step is that it may be obtained in less time than shown in the literature (15 minutes against 60 minutes tested with the use of rotary pilot ovens) and with lower electricity consumption for the same amount of material tested.

In the case of samples D and E (FIG. 5), this phase is formed in a complex mixed with silicate (Na2Ca4(PO4)2SiO4) and in the specific case of E, part of the Na+ cations bind directly with the phosphates to obtain Na3PO4. This is another water-soluble phase and is a commercially known compound in detergent applications.

Another common phase obtained for A, B, C and D is sodium/aluminum silicate (NaAlSiO4) in the form of a low flux of a particular sub-family of nepheline crystals (it forms at 900° C. and is identified as “low carnegieite”), responsible for the compaction of the powder.

In the case of E, the silicate formed contains Ca instead of Al, resulting in a compound based on NaCaSiO4.

Finally, another phase that is denoted is iron phosphide (Fe2P), and it is an important indication that the temperatures reached in the last 5 minutes of the experiment are higher than 1200° C., the minimum temperature required for the reduction of the orthophosphate, and minimum formation temperature of this phase in the presence of Fe.

Further experiments were conducted to demonstrate that the use of the insert, i.e. the refractory chamber, is necessary to allow temperatures above 1000° C. to be reached in a short time.

In the tests without the refractory cylinder, all the samples show a weight loss of only 5%, mostly linked to the transformation of the sodium bicarbonate into sodium carbonate around 200° C. and to the formation of a low-melting tectosilicate (as lysetite CaNa2Al4SiO16). For the remaining phases, all samples have intact pre-treatment phases (e.g. whitlockite and quartz) and this indicates that the treatment without a refractory cell is not effective in reaching the temperatures reached by laboratory muffle ovens or rotary ones for pilot experiments.

In cases where the insert was used instead:
after 5 minutes, for both samples F (FIG. 6A) and G only the change of sodium bicarbonate to sodium carbonate is found, except for sample F which has the Fe compound in the form of magnetite (Fe3O4) instead of hematite. Weight loss is 15%.
after 10 minutes (FIG. 6B), the weight loss is recorded at around 28% and in both samples the formation of NaCaPO4, NaAlSiO4, and also Na3PO4 for sample G is recorded. These three phases were detected for the samples where the phosphate is water-soluble and available to plants in fertilizer applications. This also indicates the temperature reached in the chamber is in the range between 800° C. and 900° C.
after 15 minutes (FIG. 6C), there is a weight loss equal to 35% and there is the formation of iron phosphide (Fe2P), indicative that the temperature has exceeded 1100° C.

Therefore, it is evident that the insert in refractory material allows thermal (1200° C.) and time (10 minutes) conditions to be obtained that are such to treat samples of ash to be stabilized and valorized for a second use, taking into account the economy and environmental impact of the process in an originally unique and alternatively innovative manner compared to processes seen in the prior art.

### EMBODIMENT EXAMPLE C: EXTRACTION OF METALS FROM LIB BATTERIES

The “black mass” (BM) samples are derived from the dismantling, shredding and grinding of lithium (Li) batteries (to be precise, low-grade cobalt (Co) NMC category) collected in recycling of batteries (of the NMC, Ni-MH, alkaline type). It is defined as “black mass” since, following mechanical pre-treatments, part of the material belonging to the anode (graphite) of the battery mixes with the material of the cathode (based on metal oxides); the dark color is attributed to the presence of graphite. As the material also contains residues of aluminum (Al) and copper (Cu), in order to remove these an oven drying was first performed at 105° C. for 1 hour with the aim of removing moisture from the material and allowing efficient subsequent sieving. Sieving took place with an ASTM Giuliani sieve with a particle size of mesh 17 (1 mm) and then mesh 35 (0.5 mm). The fine material that passes through both sieves is the one chosen to perform the experiments.

For the extraction of metals (nickel (Ni), manganese (Mn) and cobalt (Co)) from the “black mass” the method according to the present invention was used (improved microwave carbothermal process with the use of a refractory chamber) combined with an organic acid (L-malic acid) leaching process.

As regards the recovery method by the carbothermal process, the cathode material of the batteries may be represented in the general form LiNixCoyMnzO2. It is necessary to reduce these metals from the valence states in which they are found to lower valence states to increase their solubility in acidic or even aqueous solutions, and thus obtain a more efficient extraction of the metals via the subsequent leaching process.

In the case of the cathodic material available as “black mass”, the carbon is already present (generally in the form of graphite) in the material to be treated. It therefore does not necessarily have to be added to obtain the carbothermal reaction.

In the case of metal recovery, the reaction becomes, for example:

4LiNiO2(s)+C(s)→2Li2O(s)+4NiO(s)+CO2(g)

4LiCoO2(s)+3C(s)→2Li2O(s)+4Co(s)+3CO2(g)

6LiCoO2(s)+5C(s)→3Li2O3(s)+6Co(s)+CO2(g)+CO(g)

2LiMn2O4(s)+2C(s)→Li2CO3(s)+4MnO(s)+CO(g)

Therefore, in some cases the metal is obtained, and in other cases an oxide is obtained in which the metal is in a lower state of oxidation and therefore more soluble and more easily recoverable than before.

The carbon molecules (in the form, for example, of graphite) act as active absorbers of microwaves, with a consequent thermal effect which allows the heat necessary for the reduction reaction to be supplied.

By virtue of the first step of the carbothermal process with microwaves and a refractory chamber, it is possible to separate the plastics residues present as a component in the batteries from the solid matrix made up of metal oxides and graphite. Microwave heating also allows the surface area of the material to be increased so as to have greater efficiency of release into the leaching solution.

As regards the first step of the carbothermal process, the sieved sample is placed inside a graphite crucible, a cover is placed thereon and the crucible is placed inside the refractory chamber 2, which is then placed in the microwave oven. Weights are recorded using the laboratory balance before treatment and after treatment (only after complete cooling of the crucible).

The experiments in the microwave oven were performed at a set power of 1000 W, 600 W and 440 W.

The times were set in such a way as to optimize the weight loss (there must be the same weight loss % as the power varies) taking into account the energy consumption: therefore, they were set to 4 min for 1000 W, 8 min for 600 W, and 12 mins for 440 W.

TABLE 4
Microwave carbothermal process tests,
with and without a refractory chamber

| | Without refractory chamber | | With refractory chamber | |
|---|---|---|---|---|
| | Weight | initial sample | Weight | initial sample |
| Time | loss (%) | weight (g) | loss (%) | weight (g) |

Power = 440 W

| | | | | |
|---|---|---|---|---|
| t = 5 min | 1 | 0.4 | 6 | 0.44 |
| t = 10 min | 1 | 0.4 | 30 | 0.25 |
| t = 15 min | 1 | 0.5 | 30 | 0.44 |
| t = 20 min | 1.7 | 0.6 | 35 | 0.44 |
| t = 25 min | 1 | 0.7 | | |
| t = 30 min | 0.6 | 0.8 | | |

Power = 600 W

| | | |
|---|---|---|
| t = 5 min | 0.9 | 0.9 |
| t = 10 min | 1 | 0.10 |
| t = 15 min | 0.2 | 0.11 |
| t = 20 min | 0.7 | 0.12 |

Power = 1000 W

| | | |
|---|---|---|
| t = 5 min | 1 | 0.13 |
| t = 10 min | 0.4 | 0.14 |

From Table 4 it is apparent that, in the absence of the refractory chamber 2, the material has difficulty in varying its weight both with variations in power and in time. This means that, without the refractory chamber 2, the material does not reach temperatures that are such to cause at least the component of the polymer residues to volatilize. The weight loss averages 1% which is linked to the humidity accumulated by the material on the surface of the particles. In the case instead in which the refractory chamber 2 is used, an increasingly marked change in weight is evident as time varies with the same power.

TABLE 5
Post microwave heat treatment samples to be leached

| | Power | Time | Refractory | Weight |
|---|---|---|---|---|
| Sample | (W) | (mins) | chamber | loss % |
| P1 | 1000 | 4 | no | 1 |
| PR1 | 1000 | 4 | yes | 29 |
| P2 | 600 | 8 | no | 1 |
| PR2 | 600 | 8 | yes | 29 |
| P3 | 440 | 12 | no | 1 |
| PR3 | 440 | 12 | yes | 30 |

In the subsequent leaching step, L-malic acid is used as it is a cost-effective reagent to produce, it has no emissions unlike inorganic acids and less is consumed for the same material to be leached. Overall, therefore, this reagent is more sustainable. The reagent for the leaching tests is therefore L-malic acid (99%), accompanied by hydrogen peroxide (30% w/w) used as a reducing reagent to make the release of metals into the acidic solution more efficient.

TABLE 6
Results of TXRF analyzes on sample leachates
after optimized microwave treatment

Sample

| | P1 | PR1 | PR2 | PR3 |
|---|---|---|---|---|
| Element | (mg/L) | (mg/L) | (mg/L) | (mg/L) |
| Mn | 1285 | 2712 | 1735 | 1007 |
| Fe | 208 | 412 | 259 | 207 |
| Co | 1031 | 2573 | 1334 | 1008 |
| Ni | 1996 | 3501 | 1439 | 1493 |
| Cu | 181 | 11 | 0 | 0 |

The analysis regarding the post-heat treatment acid leaching shows that the extraction percentage (release of metals) in the case of treatment with a refractory chamber 2 is respectively above 90% for Co, Fe and Mn, while Ni is around 70%. Instead, in the case of the heat-treated sample without the use of the refractory chamber (P1), the value of the concentration of the elements is at least halved for all the metals under examination. This result indicates that the use of the refractory chamber 2 is responsible for this more efficient release of the metals into the acidic solution, allowing this step of the process to be made efficient, a benefit which adds to the already effective removal of plastics residues in more sustainable times and in terms of energy consumption compared to the classical method of pyrolysis of the material.

Innovatively, the heating properties of the microwaves are particularly suitable for the thermal treatment of dielectric materials, which are capable of absorbing the microwaves (such as carbon for example), also allowing a homogeneous thermal treatment. The treatment carried out with this technology turns out to be more efficient, rapid and sustainable than the classic treatments operated with ovens that use non-renewable energy sources (such as coal) or other electric ovens which do not use microwaves. With the proposed technology it is possible to reach temperatures over 1000° C. even in a few minutes, allowing a (carbothermal) reduction reaction to be carried out in an efficient and rapid manner. Advantageously furthermore, the use of a graphite crucible positioned in a refractory chamber 2 with an internal graphite covering allows higher temperatures to be reached (even above 500° C.) with respect to those obtained in a simple microwave oven.

The innovation of the present method consists in obtaining the carbothermal reaction in less time than shown in the literature (15 minutes against 60 minutes tested with the use of rotary pilot ovens) and with lower electricity consumption.

It is clear that those skilled in the art may make changes to the method described above in order to meet incidental needs, all falling within the scope of protection defined in the following claims.

What is claimed is:

1. A method for recovering materials from waste or scraps through an improved microwave carbothermal process, the method comprising:
combining reagents of a carbothermal reaction to form a mixture to be subjected to heat treatment, said reagents comprising a component in which an element to be recovered is contained, a carbon-containing component and optionally an additive, wherein the component is contained within a waste material;
placing the mixture in a crucible;
placing the crucible in a refractory chamber comprising a side wall surrounding an inner chamber in which the crucible is arranged; wherein said side wall is made of a refractory material and is provided with a surface facing the inner chamber; and wherein said surface of the side wall is covered by a layer made of microwave-sensitive material; and
inserting the refractory chamber into a microwave oven operated at a power W for a time T.

2. The method of claim 1, wherein the side wall is made of ceramic and the layer is made of carbon, graphite, or silicon carbide.

3. The method of claim 1, wherein the crucible is made of microwave-sensitive material.

4. The method of claim 3, wherein the crucible is made of carbon, graphite, or silicon carbide.

5. The method of claim 1, wherein the carbon-containing component is also waste material.

6. The method of claim 1, wherein the component in which the element to be recovered is contained is powder, ash, slag, sludge, or other material containing an element in an oxidized state which may be transformed into a reduced form thereof.

7. The method of claim 1, wherein the element to be recovered is phosphorus and the carbothermal reaction may be schematized as:
2Ca₃(PO₄)₂+10C+3SiO₂->3Ca₂SiO₄+10CO+2P₂
wherein the component in which the element to be recovered is contained results from biomass ashes or chicken manure ash or sewage sludge ashes, the additive is silica fume or colloidal silica, and the carbon-containing component is activated carbon or anthracite or graphite.

8. The method of claim 1, wherein:
the component is black mass powder from lithium battery recycling, referable to as LiNiₓCo_{y}Mn_{z}O₂;
the element to be recovered is at least one of lithium oxide, nickel oxide, manganese oxide, cobalt oxide, or other meta/oxide;
carbon is already present in the form of graphite in the black mass; and
the carbothermal reaction may be, depending on starting material:
4LiNiO₂(s)+C(s)→2Li₂O(s)+4NiO(s)+CO₂(g) or
4LiCoO₂(s)+3C(s)→2Li₂O(s)+4Co(s)+3CO₂(g) or
6LiCoO₂(s)+5C(s)→3Li₂O₃(s)+6Co(s)+CO₂(g)+CO(g) or
2LiMn₂O₄(s)+2C(s)→Li₂CO₃(s)+4MnO(s)+CO(g).

9. The method of claim 1, wherein the element to be recovered is phosphorus and the carbothermal reaction may be schematized as:
Ca₃(PO₄)₂+6NaHCO₃→2Na₃PO₄+3Ca(OH)₂+6CO₂
wherein the component in which the element to be recovered is contained results from sewage sludge ashes, the additive is sodium bicarbonate or another sodium or potassium salt or a bromide or an iodide, and the carbon-containing component is graphite or a dewatered sludge.

10. The method of claim 1, wherein a bell is positioned inside the refractory chamber, and wherein the bell defines a controlled atmosphere compartment in which the crucible is placed.

11. The method of claim 10, wherein said bell is made of a material transparent to microwaves, and is provided with an inlet channel and an outlet channel for a gas.

12. A refractory chamber for recovering elements from a waste material through a microwave carbothermal process, comprising:
an inner chamber in which the waste material to be subjected to the microwave carbothermal process is insertable; and
a side wall provided with a surface facing the inner chamber;
wherein said side wall is made of a refractory material; and
wherein the surface of the side wall facing the inner chamber is covered by a layer of a microwave-sensitive material.

13. The refractory chamber of claim 12, wherein said side wall is made of ceramic and the layer is made of carbon, graphite, or silicon carbide.
